(19) United States
(12) Patent Application Publication
(10) Pub. No.: US 2003/0173777 A1
(43) Pub. Date: Sep. 18, 2003

(54) Clamp used in branching a soft hose

(76) Inventor: In Seon Jeong, Seoul (KR)

Correspondence Address: DARBY & DARBY P.C., P. O. BOX 5257, NEW YORK, NY, 10150-5257, US

(21) Appl. No.: 10/343,149

(22) PCT Filed: Jul. 25, 2001
(86) PCT No.: PCT/KR01/01267

(30) Foreign Application Priority Data
Jul. 25, 2000 (KR) 2000/21216 U

(51) Int. Cl. F16L 5/00

(52) U.S. Cl. 285/197

(57) ABSTRACT

A clamp used in branching a soft hose, by which fluid can flow from the main hose to a branch hose more smoothly. The clamp includes inner and outer pressing plates to be in tight contact with inner and outer surfaces of a main hose, a nipple integrated with the inner pressing plate, and an assembling tube having a watertight ring fitted around the nipple. The main hose has an ellipsoidal opening elongated in a longitudinal direction of the main hose, and the inner pressing plate is also ellipsoidal shape and its area is larger than that of the opening. The nipple has hoding jaws and the outer pressing plate has a through hole, through which the assembling tube is fitted. A nut is fitted under the nipple of the asembling tube after the outer pressing plate is fitted, and the branch hose is fitted around the nipple.

### BACKGROUND OF THE INVENTION

1. Field of the Invention

The present invention relates to a connector used in branching a hose, and more particularly to a clamp having a hose-connecting tube for branching and a pair of arc-shaped plates to be in tight contact with inner and outer surfaces of a main hose, so as to enable fluid to smoothly flow from the main hose to a branch hose and to increase the durability of the hose.

2. Description of the Prior Art

In general, when water is supplied to plant in a wide cultivated area or to grass in such areas as an athletic field and a park, a main hose having a large diameter is located at a proper position in the area to be watered and a plurality of branch hoses branching off from the main hose are arranged with regular intervals, so as to uniformly supply water to the wide area to be watered.

In this case, in order to connect the branch hoses with the main hose, employed is a connector having such a shape as a letter “T” and a clamp. U.S. Pat. No. 4,637,638, entitled “Branched hose construction, joint construction and part therefor, and methods of making the same”, issued to Rush, et al., discloses a connector having a shape of a letter “T”, which includes a flat head and a body tube vertically connected to the head. The head is a portion to be forcedly inserted into an opening formed through a soft main hose. The body tube has a screw formed at an intermediate portion of the body tube and an enlarged-diameter portion formed at an end of the body tube, so that a nut can be assembled on the screw and a branch hose can be inserted in the enlarged-diameter portion. The nut is assembled in order to stably maintain a joint between the head and the main hose, which is to be in tight contact with an upper surface of the head, and to thereby provide the joint portion between them with a water-tightness.

The head of the T-shaped branching tube, the connector, is inserted in the opening of the main hose. Since the area of the head is larger than the opening of the main hose, the head is forcedly inserted into the opening while the opening is elastically expanded. The body tube of the T-shaped branching tube extends perpendicularly from the main hose. An outer pressing plate having the same shape and the same area as those of the head is inserted in the body tube. After the outer pressing plate is inserted, the nut is assembled. The branch hose is forcedly fitted to the end of the body tube, with which the nut has been assembled.

In this case, the main hose has to be soft since the head of the T-shaped branching tube has to be forcedly inserted into the opening of the main hose. However, in the case where the main hose is made from a hard material or a material, which is not elastic in both transverse and longitudinal directions of the material, such as a tarpaulin sheet, which is made by coating vinyl resin on a tent cloth, the T-shaped branching tube cannot be employed since the head cannot be inserted into the opening of the main hose.

Also, there is another problem that a stable joint state is not maintained in the joint portion by the T-shaped branching tube. That is, when the water-tightness between the main hose and the head of the T-shaped branching tube is not maintained well, the main hose is apt to be broken due to a local stress generated by an internal pressure, since the main hose, which is in tight contact with an end portion of the head of the T-shaped branching tube, is made from a soft material while the head of the T-shaped branching tube is made from a hard material.

Further, in the case where the main hose is constituted by a cylindrical synthetic resin tube together with a plurality of fiber core materials extending in the longitudinal direction of the tube, which function as reinforcements, the main hose repeatedly undergoes expansions and contractions due to a change of hydraulic pressure according to the flow of water or other external factors. In this case, the fiber core materials are not deformed but maintain their original states, while only the synthetic resin tube undergoes the repetitive expansions and contractions. Therefore, since the pressure-resistance of the end portion of the soft hose connected to the branching tube is largely reduced when it is expanded, the end portion of the soft hose may be twisted or may move with violence due to the change of the internal hydraulic pressure and the external factors. Moreover, such twist or violent movement may produce such a deformation as wrinkles on the surface of the soft hose, which may disturb a smooth flow of fluid in the soft hose. In addition, the hose may get torn or broken, so that the life span of the hose is shortened and the durability of the hose is reduced.

Moreover, in the case where the main hose and the branch hose are jointed with each other by means of a connector having a shape of a pair of clamps in such a manner as that the main hose is seated inside of the connector, the connector can be utilized only when the main hose is a hose maintaining a shape of a cylindrical tube. In contrast, the connector cannot be employed when the main hose is a hose, which can be freely folded without a predetermined shape.

### SUMMARY OF THE INVENTION

Accordingly, the present invention has been made to solve the above-mentioned problems occurring in the prior art, and an object of the present invention is to provide a clamp used in branching a hose, which can be efficiently employed in a flexible hose, which is not expansible in transverse and longitudinal directions of the hose.

It is another object of the present invention is to provide a clamp used in branching a hose, which includes a hose-connecting tube for branching and a pair of arc-shaped plates to be in tight contact with inner and outer surfaces of a main hose, so as not only to enable fluid to smoothly flow from the main hose to a branch hose, but also to be more efficiently employed in a hose which is freely foldable without maintaining a shape of a cylindrical tube.

In order to accomplish this object, there is provided a clamp used in branching a soft hose, the clamp connecting the soft hose, which is a main hose, with a branch hose, which branches off from the main hose in a predetermined direction, the clamp comprising: an inner pressing plate having a plate-shaped construction, the inner pressing plate having a sectional shape which is complementary to an inner surface of the main hose, the inner pressing plate having a branching hole formed at a center of the inner pressing plate, the main hose having an opening, the opening having an ellipsoidal shape which is elongated in a longitudinal direction of the main hose, the inner pressing plate having an ellipsoidal shape whose area is larger than an area of the opening; a nipple integrated with the branching hole of the inner pressing plate, the nipple protruding in a predetermined direction in such a manner as to be fitted into the branch hose, the nipple having a bolt portion formed at a side of the inner pressing plate, the nipple having a plurality of holding jaws formed at an end of the nipple; an assembling tube including a watertight ring with a high elasticity, which is fitted around a portion behind the holding jaws of the nipple; and an outer pressing plate having a plate-shaped construction which is equal to that of the inner pressing plate, the outer pressing plate having a through hole formed at a center of the outer pressing plate, through which the assembling tube passes, the outer pressing plate being assembled with the inner pressing plate while being in contact with an outer surface of the main hose.

A nut is fitted around the bolt portion formed at a portion under the nipple of the assembling tube after the outer pressing plate is fitted, and the branch hose is fitted around the nipple. The end of the branch hose is fitted up to a portion above the watertight ring of high elasticity and is fastened at the portion above the watertight ring by the assembling ring made from a metal sheet.

A nut seating portion to be in tight contact with the lower surface of the assembling nut is formed around the through hole of the outer pressing plate. Further, an engagement groove is formed along an edge of the upper surface of the inner pressing plate, and an engagement protuberance is formed along an edge of the outer pressing plate, the engagement protuberance being inserted in the engagement groove. Moreover, a packing member having a high elasticity and a shape of a plate is interposed between the upper surface of the inner pressing plate and the inner surface of the main hose.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view of a clamp used in branching a soft hose according to the present invention, for showing the entire construction thereof;

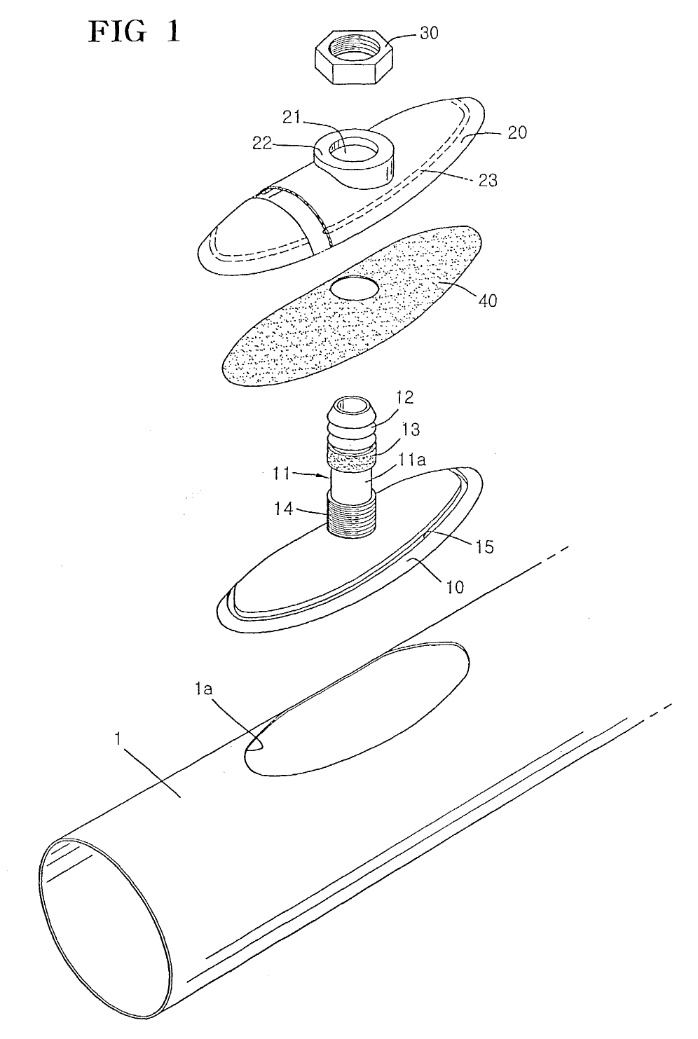

FIG. 2 is a partial side view of a main hose and an inner pressing plate employed in a clamp according to the present invention, for showing a method of fitting an assembling tube in the main hose; and

FIG. 3 is a sectional view of a main hose and a branch hose connected with each other by a clamp according to the present invention.

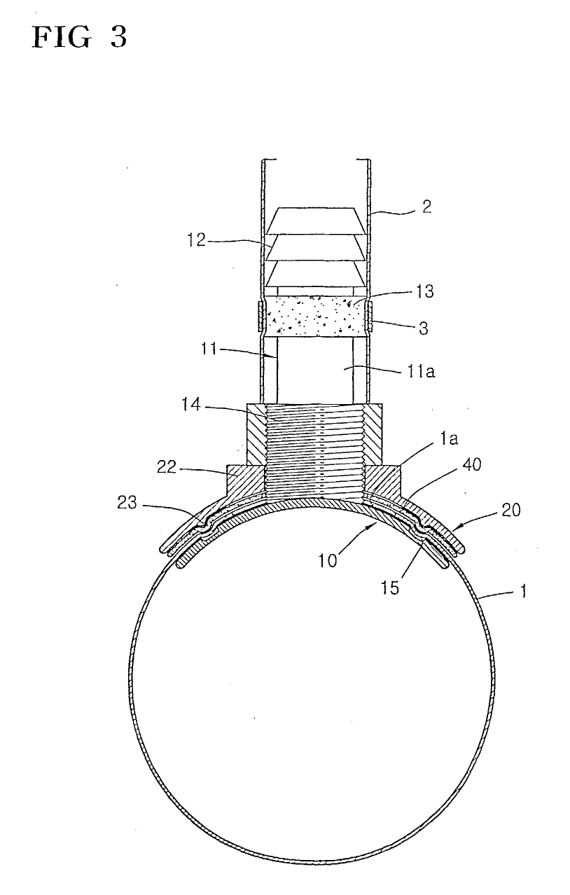

### DETAILED DESCRIPTION OF THE PREFERRED EMBODIMENTS

Hereinafter, a preferred embodiment of the present invention will be described with reference to the accompanying drawings.

As shown, a clamp used in branching a soft hose according to the present invention is a device for connecting a main hose 1 and a branch hose 2, which branches out in a predetermined direction from the main hose 1. The clamp includes an inner pressing plate 10 and an outer pressing plate 20, which are disposed respectively inside and outside of the main hose 1 in the longitudinal direction of the main hose 1, and an assembling tube 11 having a nipple 11a, which protrudes in a predetermined outward direction from a branch hole of the inner pressing plate 10 to be connected with the branch hose.

That is, the clamp has a construction of a pair of pressing plates respectively having an arc-shaped section. The inner pressing plate 10 formed at one end of the assembling tube 11, whose upper end is to be connected with the branch hose 2, is inserted into the main hose 1, which is made from a soft material, to be in tight contact with an inner surface of the main hose 1. The outer pressing plate 20 having a through hole 21, through which the nipple 11a can pass, is assembled with the inner pressing plate 10 in such a manner as that the outer pressing plate 20 is in tight contact with an outer surface of the main hose 1 and presses the main hose 1 onto an upper surface of the inner pressing plate 10.

Hereinafter, described in detail will be the construction of the clamp according to the present invention as described above.

First, the inner pressing plate 10 is inserted into the main hose 1 through an opening 1a, which is formed at a predetermined portion of the main hose 1, and has an arcuate shape so as to be in tight contact with the inner surface of the main hose 1.

As described above, the inner pressing plate 10 is formed in such a manner as that an area of a portion of the inner pressing plate 10 to be in contact with the main hose 1 is larger than the dimension of the opening 1a. Therefore, it is preferred that the inner pressing plate 10 and the opening 1a are respectively formed to have an ellipsoidal shape, so that the inner pressing plate 10 can be smoothly inserted into the opening 1a.

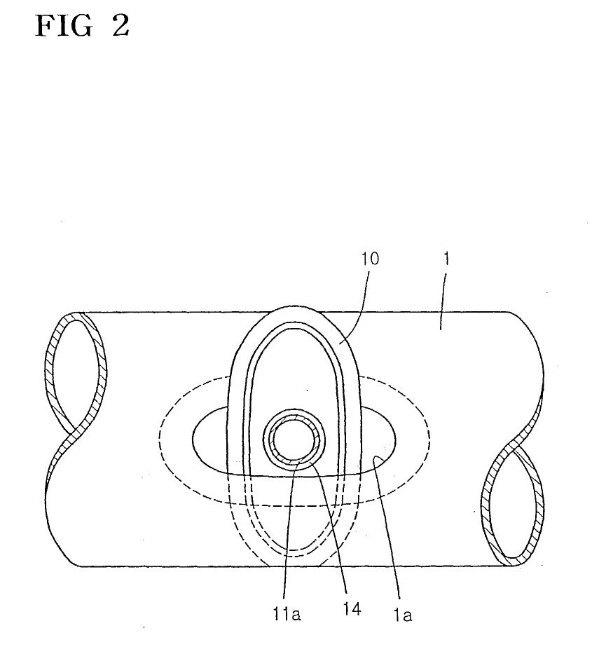

That is, as shown in FIG. 2, the inner pressing plate 10 is firstly erected so that its shorter diameter is to be in parallel with the main hose 1, and the inner pressing plate 10 is gradually inserted into the opening 1a from a lower end of the inner pressing plate 10 and the inner pressing plate 10 is made to be completely inserted in the opening 1a in a state that the inner pressing plate 10 is aligned in the same direction with that of the opening 1a.

Moreover, one the assembling tube 11 is constructed by vertically forming the nipple 11a at the upper surface of the inner pressing plate 10 as described above. In this case, the nipple 11a of the assembling tube 11 is connected with the arcuate plate of the inner pressing plate 10 and protrudes out of the main hose 1 through the opening 1a.

Further, the nipple 11a of the assembling tube 11 is assembled with one end of the branch hose 2, which is designed to branch off from the main hose 1. After the branch hose 2 is fitted around an outer surface of the nipple 11a, an assembling ring 3 such as a band clamp is assembled around the nipple 11a. In this case, it is preferred that a plurality of holding jaws 12 for holding the assembling ring 3 so as to prevent the assembling ring 3 from moving may extend in the radial direction around the circumference of the nipple 11a, so that the assembling ring 3 can hold the branch hose 2 while a more stable assembled state of the assembling ring 3 with the assembling tube 11 is maintained and the assembling ring 3 is prevented from sliding along the surface of the branch hose 2.

Furthermore, in a state that a watertight ring 13 is interposed between the nipple 11a and the branch hose 2, the assembling ring 3 is assembled in such a manner as to surround the watertight ring 13. In result, the joint portion between the branch hose 2 and the assembling tube 11 is maintained in a closer watertight state, and the two members are maintained in a more stable assembled state.

That is, the watertight ring 13 has a band-shaped construction with a predetermined height, so as to be fitted around the nipple 11a of the assembling tube 11. In the state where the branch hose 2 is fitted around the nipple 11a, with which the watertight ring 13 is assembled, the assembling ring 3 is assembled on an outer surface of the branch hose 2, which is in contact with the watertight ring 13.

By this construction, the watertight ring 13 is pressed to come into tight contact with the nipple 11a, so that the contact surface between the nipple 11a and the branch hose 2 is maintained in a closer watertight state. Further, since the assembling ring 3 is in its assembled state while fastening the watertight ring 13 having a strong adhesive power, the assembling ring 3 is prevented from moving along the assembling tube 11, so as to hold the branch hose 2 more stably.

Furthermore, a nut 30 is fitted around a bolt portion 14 of the nipple 11a, which is formed from a portion in contact with the inner pressing plate 10, after the nipple 11a and the outer pressing plate 20 are assembled with each other. Likewise with the inner pressing plate 10, the outer pressing plate 20 also has an arcuate shape, which enables the outer pressing plate 20 to press the main hose 1 onto the inner pressing plate 10 when it has been assembled. Moreover, a portion of the outer pressing plate 20 in contact with the main hose 1 also has an area larger than the size of the ellipsoidal opening 1a perforated in the main hose 1, so that the outer pressing plate 20 presses the circumference of the opening 1a when the outer pressing plate 20 is assembled with the inner pressing plate 10.

Also, the through hole 21 is perforated through the center of the outer pressing plate 20, so that the bolt portion 14 and the assembling tube 11 of the inner pressing plate 10 pass through the through hole 21. When the nut 30 is fitted and fastened on the bolt portion 14, which has been inserted through the through hole 21, the outer pressing plate 20 and the inner pressing plate 10 are assembled with each other while respectively coming into tight contact with inner and outer surfaces of the main hose 1 interposed between them, so that they are fixed to the main hose 1.

Moreover, in order to prevent a phenomenon in which the pressing force is concentrated at an upper portion of the outer pressing plate 20 when the horizontal bottom surface of the nut 30 presses the acruate surface of the outer pressing plate 20, it is preferred that a nut seating portion 22 protruding upward is disposed around the through hole 21 of the outer pressing plate 20, so that the pressing force by the nut 30 can be uniformly transferred to the entire surface of the outer pressing plate 20.

Further, although the present embodiment employs a construction in which the inner pressing plate 10 and the outer pressing plate 20 are assembled by means of a bolt and a nut, it will be apparent to those related in the art that the present invention may employ other assembling constructions with various forms.

In addition, it is preferred that an engagement groove 15 and an engagement protuberance 23 are respectively formed at the upper surface of the inner pressing plate 10 and at the lower surface of the outer pressing plate 20, so that the inner pressing plate 10 and the outer pressing plate 20 can be more firmly assembled with the main hose 1.

That is, in the case where the circumference of the opening 1a of the main hose 1 is fastened between the outer pressing plate 20 and the inner pressing plate 10 constituting the horizontal surface, there is a great danger in that the inner pressing plate 10 may slide on and be separated from the inner pressing plate 10 and the outer pressing plate 20 by the hydraulic pressure of the supplied water or other external factors.

Therefore, the engagement protuberance 23 and the engagement groove 15 are formed at the contact surfaces of the inner pressing plate 10 and the outer pressing plate 20 as described above, so that the engagement protuberance 23 is inserted in the engagement groove 15 while pressing the soft main hose 1. In result, the inner pressing plate 10 and the outer pressing plate 20 are not separated from the branch hose 2, but the assembled state between them is stably maintained.

Further, it is preferred that a packing member 40 having a shape of a plate and a high elasticity is disposed at the assembled portion between the inner pressing plate 10 and the outer pressing plate 20, so that the joint portion between the two members can be maintained in a closer watertight state and the inner pressing plate 10 can be more firmly assembled in the inner surface of the main hose 1.

That is, the packing member 40 is attached between the upper surface of the inner pressing plate 10 and the inner surface of the main hose 1, so that the contact surface between the inner pressing plate 10 and the circumference of the opening 1a of the main hose 1 is maintained in a closer watertight state. Further, since the packing member 40 having a strong viscosity is disposed between the inner surface of the main hose 1 and the inner pressing plate 10, the inner surface of the main hose 1 and the inner pressing plate 10 are prevented from sliding on each other and are maintained in a firmly adhered state.

As apparent from the embodiments of the present invention as described above, by the clamp used in branching a hose according to the present invention, the joint portion between a soft main hose and a connector for connecting a branch hose with the main hose can be always maintained in a stable assembled state, so that fluid can smoothly flow through the connector.

The clamp of the present invention can be employed in all kinds of soft hoses, and can be more efficiently utilized particularly in branching a soft hose named a tarpaulin, which is freely foldable without maintaining a type, in which vinyl resin is coated on a tent cloth woven as a polyethylene union cloth.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A clamp used in branching a soft hose, the clamp connecting the soft hose, which is a main hose, with a branch hose, which branches off from the main hose in a predetermined direction, the clamp comprising:
an inner pressing plate having a plate-shaped construction, the inner pressing plate having a sectional shape which is complementary to an inner surface of the main hose, the inner pressing plate having a branching hole formed at a center of the inner pressing plate, the main hose having an opening, the opening having an ellipsoidal shape which is elongated in a longitudinal direction of the main hose, the inner pressing plate having an ellipsoidal shape whose area is larger than an area of the opening;
a nipple integrated with the branching hole of the inner pressing plate, the nipple protruding in a predetermined direction in such a manner as to be fitted into the branch hose, the nipple having a bolt portion formed at a side of the inner pressing plate, the nipple having a plurality of holding jaws formed at an end of the nipple;
an assembling tube including a watertight ring with a high elasticity, which is fitted around a portion behind the holding jaws of the nipple; and
an outer pressing plate having a plate-shaped construction which is equal to that of the inner pressing plate, the outer pressing plate having a through hole formed at a center of the outer pressing plate, through which the assembling tube passes, the outer pressing plate being assembled with the inner pressing plate while being in contact with an outer surface of the main hose.

2. A clamp used in branching a soft hose as claimed in claim 1, wherein the inner pressing plate has an engagement groove formed along an edge of the inner pressing plate, and the outer pressing plate has an engagement protuberance formed along an edge of the outer pressing plate, the engagement protuberance being inserted in the engagement groove.

3. A clamp used in branching a soft hose as claimed in claim 1, the clamp further comprising a packing member interposed between an upper surface of the inner pressing plate and an inner surface of the main hose, the packing member having a high elasticity and a shape of a plate.
